(19) United States
(12) Patent Application Publication
(10) Pub. No.: US 2009/0278463 A1
(43) Pub. Date: Nov. 12, 2009

(54) POWER INTERRUPTION PROTECTION STRUCTURE FOR LED STRING LIGHT

(76) Inventor: Tai-Ning TANG, Honolulu, HI (US)

Correspondence Address: RABIN & Berdo, PC, 1101 14TH STREET, NW, SUITE 500, WASHINGTON, DC, 20005, US

(21) Appl. No.: 12/115,602

(22) Filed: May 6, 2008

(51) Int. Cl. H05B 37/00; H01H 73/00

(52) U.S. Cl. 315/185 S; 361/115

(57) ABSTRACT

A power interruption protection structure for an LED string light implements a Zener diode connected between an anode and a cathode inside or outside a casing of each of plural monochromatic or polychromatic LEDs that are connected in series to form the LED string light. In case of a burnout or breakdown of one of the LEDs, the Zener diode provided at the malfunctioning LED serves to instantly restore electrical conduction, allowing the LED string light to function normally without interruption. Accordingly, failure of one or some of the LEDs does not affect the LED string light as a whole.

### BACKGROUND OF THE INVENTION

1. Field of the Invention

The present invention relates to a power interruption protection structure for an LED string light, and more particularly, to a protective structure implementing a Zener diode connected between an anode and a cathode inside or outside a casing of each of plural monochromatic or polychromatic LEDs that are connected in series as an LED string light so that in case of a burnout or breakdown of one or more than one of the LEDs, the Zener diode provided at the malfunctioning LED serves to restore electrical conduction instantly, allowing the LED string light to function normally without interruption.

2. Description of Related Art

LEDs are power-saving and generate little heat, and thus LEDs are replacing conventional light bulbs and are in wide use with a variety of light sources. LEDs, coupled with various control components or circuits, generate light in different ways as appropriate. There are two types of LEDs for use with string lights, namely single-bulb monochromatic LEDs and single-bulb polychromatic LEDs. An LED string light is composed of a plurality of single-bulb monochromatic LEDs connected in series and in a random order, and the LED string light as a whole is driven and controlled by a rectifying circuit, thereby allowing the single-bulb monochromatic LEDs of the LED string light to glitter by alternating between ON and OFF states in a pre-programmed sequence. Where an LED string light comprises a plurality of single-bulb polychromatic LEDs connected in series, a plurality of LED chips of different colors, a variable resistor, and a control IC for controlling alternation of ON and OFF states are disposed inside a casing of each of the LEDs. Likewise, the LED string light is equipped with a rectifying circuit to drive the control IC inside the casing of each of the LEDs and enable the control IC to control the LED chips inside the casing of each of the LEDs, thereby allowing the LED chips to drive the single-bulb monochromatic LEDs of the LED string light to glitter by alternating between ON and OFF states in a pre-programmed sequence. However, the conventional LED string light as a whole will fail and fade out whenever one or some of the LEDs in use break down or burn out, whether the conventional LED string light comprises single-bulb monochromatic LEDs or single-bulb polychromatic LEDs because the malfunctioning LED/LEDs break the series-connected circuit of the LED string light. In such a situation, ordinary users are unable to fix the LED failure independently. However, an overhaul carried out by the manufacturer entails counting all the LEDs one by one (in general, a string light consists of dozens to hundreds of bulbs) to identify the malfunctioning LED, causing the overhaul time-consuming and laborious. Accordingly, the conventional LED string light still has room for improvement.

### SUMMARY OF THE INVENTION

In view of the drawback of the conventional LED string light wherein the whole LED string light fails and fades out whenever one or some of the LEDs thereof fail, the inventor of the present invention, basing on his years of practical experience, diligent research, long deliberation and repeated experiments, to eventually provide a power interruption protection structure for an LED string light, wherein a Zener diode is connected across each of monochromatic or polychromatic LEDs of the LED string light such that, in case of failure of one of the LEDs, the Zener diode provided at the malfunctioning LED will instantly restore electrical conduction due to the electronic properties of Zener diodes, allowing the LED string light to function normally, well, and without interruption, and allowing the malfunctioning LED to be instantly identified to facilitate maintenance and replacement.

### BRIEF DESCRIPTION OF DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a first preferred embodiment according to the present invention showing a single-bulb monochromatic LED with a Zener diode connected between an anode and a cathode inside the casing of the LED;

FIG. 2 is a perspective view of a second preferred embodiment according to the present invention showing a single-bulb monochromatic LED with a Zener diode connected between an anode and a cathode outside the casing of the LED;

FIG. 3 shows a circuitry of the first preferred embodiment where the single-bulb monochromatic LED has the Zener diode connected between the anode and the cathode inside the casing of the LED;

FIG. 4 shows a circuitry of a the second preferred embodiment where the single-bulb monochromatic LED has the Zener diode connected between the anode and the cathode outside the casing of the LED;

FIG. 5 shows a circuitry of a string light comprising a plurality of the single-bulb monochromatic LEDs of the first embodiment connected in series;

FIG. 6 shows a circuitry of a string light comprising a plurality of the single-bulb monochromatic LEDs of the second embodiment connected in series;

FIG. 7 is a perspective view of a third preferred embodiment according to the present invention showing a single-bulb polychromatic LED with a Zener diode connected between an anode and a cathode inside a casing of the LED;

FIG. 8 is a perspective view of a fourth preferred embodiment according to the present invention showing a single-bulb polychromatic LED with a Zener diode connected between an anode and a cathode outside a casing of the LED;

FIG. 9 shows a circuitry of the third preferred embodiment where the single-bulb polychromatic LED has the Zener diode connected between the anode and the cathode inside the casing of the LED;

FIG. 10 shows a circuitry of the fourth preferred embodiment where the single-bulb polychromatic LED has the Zener diode connected between the anode and the cathode outside the casing of the LED;

FIG. 11 shows a circuitry of a string light comprising a plurality of the single-bulb polychromatic LEDs of the third embodiment connected in series; and

FIG. 12 shows a circuitry of a string light comprising a plurality of the single-bulb polychromatic LEDs of the fourth embodiment connected in series.

### DETAILED DESCRIPTION OF THE PREFERRED EMBODIMENTS

The following preferred embodiments are provided to illustrate the disclosure of the present invention, these and other advantages and effects can be apparently understood by those skilled in the art after reading the disclosure of this specification in conjunction with the accompanying drawings.

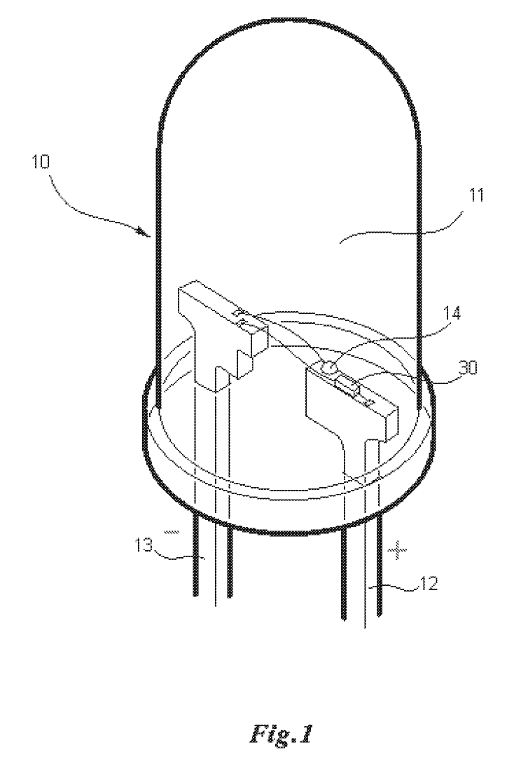

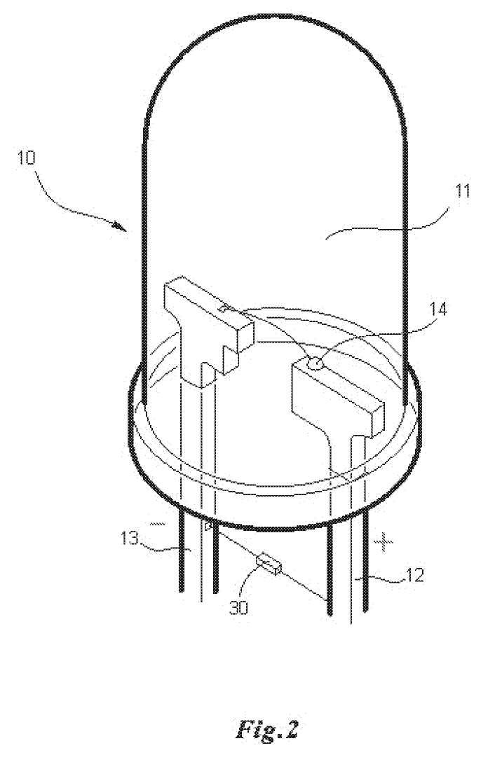

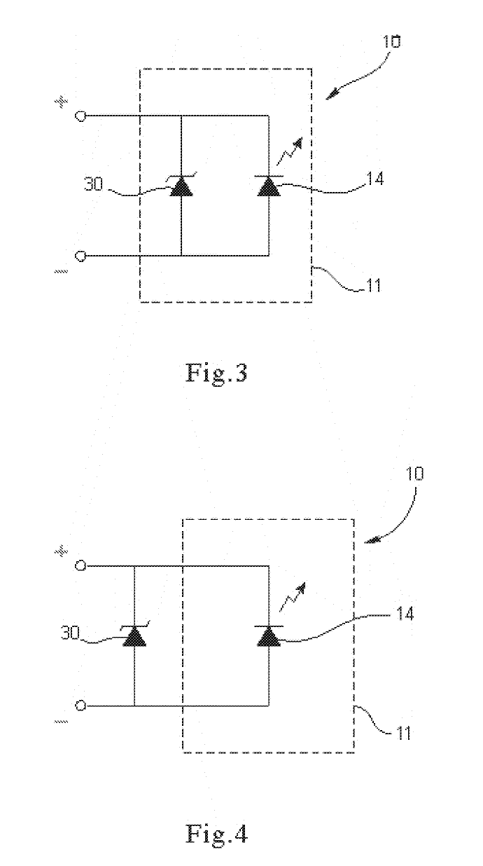

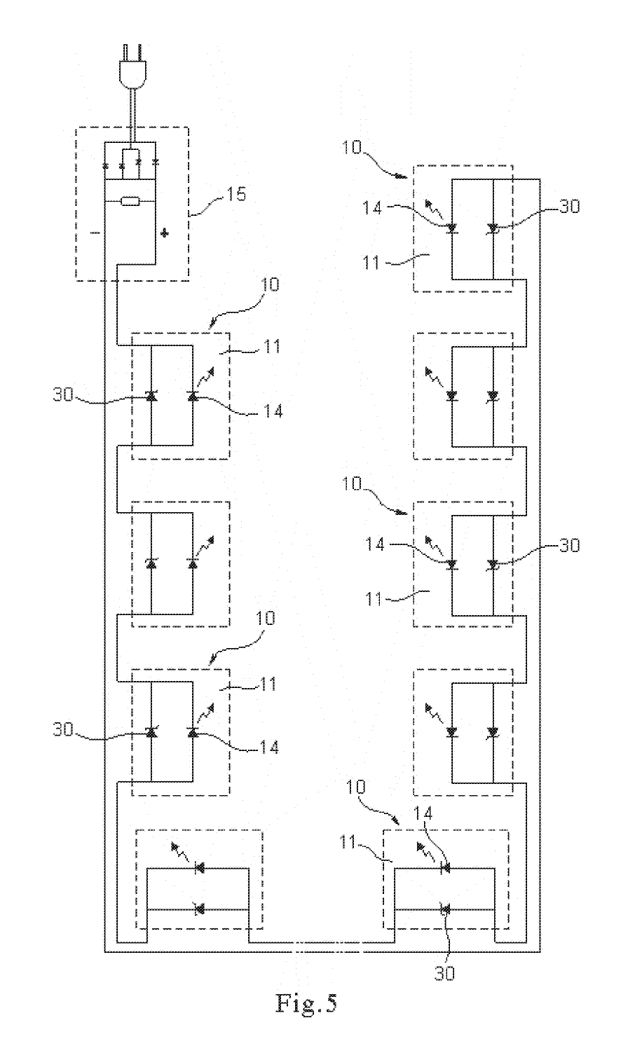

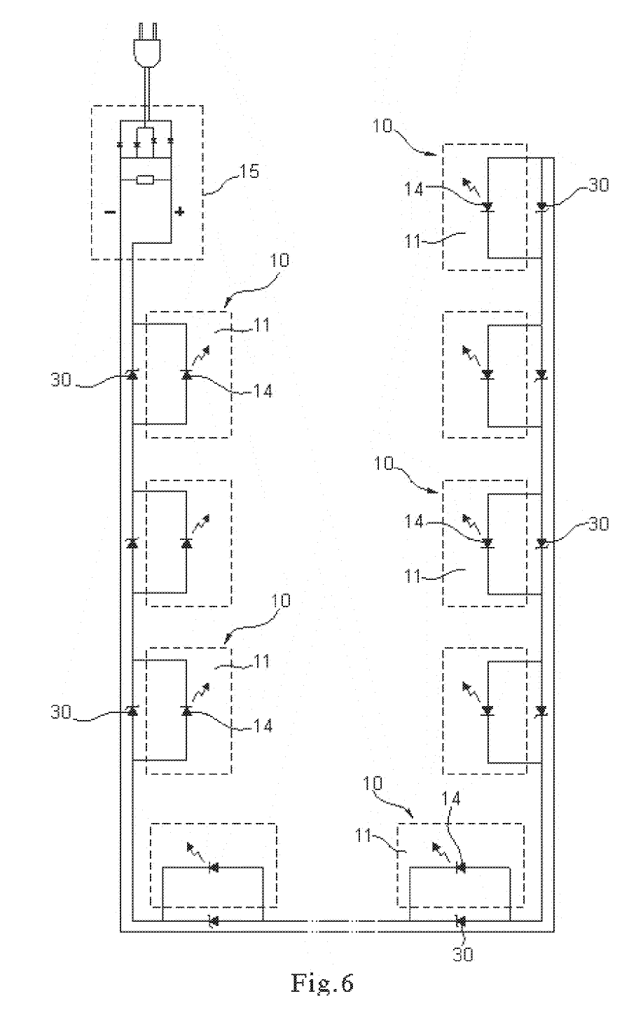

FIGS. 1 to 6 provide a first and a second preferred embodiments of the present invention relating to single-bulb monochromatic LEDs 10. In the single-bulb monochromatic LED 10, an anode pin 12 and a cathode pin 13 are provided inside a casing 11, and an LED chip 14 is disposed at an end portion of the anode pin 12. A plurality of the single-bulb monochromatic LEDs 10 are connected in series to form an LED string light. The LED string light is equipped with a rectifying circuit 15 for providing a low DC voltage and a control program so as to drive and control each of the single-bulb monochromatic LEDs 10 to glitter by alternating between ON and OFF states in a pre-programmed sequence. The present invention is characterized by a Zener diode 30 is connected between the anode pin 12 and the cathode pin 13 of each of the single-bulb monochromatic LEDs 10. The Zener diode 30 between the anode and cathode pins 12, 13 may be settled inside or outside the casing 11. Once power interruption arises from a failure of one of the single-bulb monochromatic LEDs 10 of the LED string light, the Zener diode 30 connected between the anode and cathode pins 12, 13 of the malfunctioning single-bulb monochromatic LED 10 will instantly restore electrical conduction, allowing the LED string light to function normally, well, and without interruption. Accordingly, a power interruption protection structure for an LED string light of the present invention excels a conventional LED string light for preventing complete failure, and allowing the malfunctioning single-bulb monochromatic LED 10 to be identified with naked eyes so to facilitate maintenance and replacement.

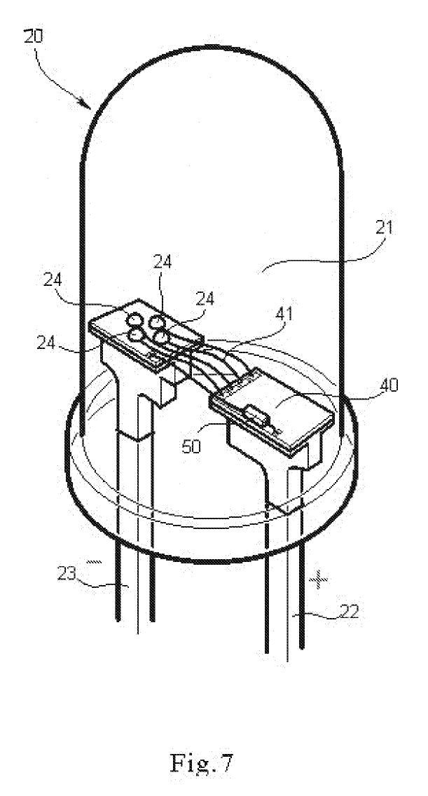

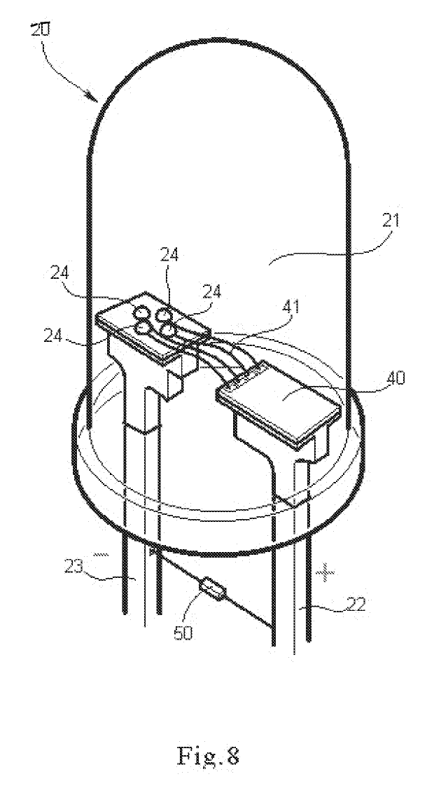

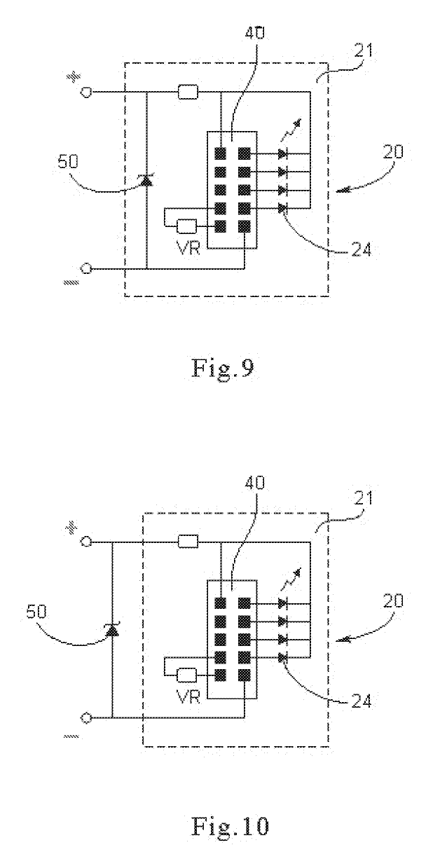

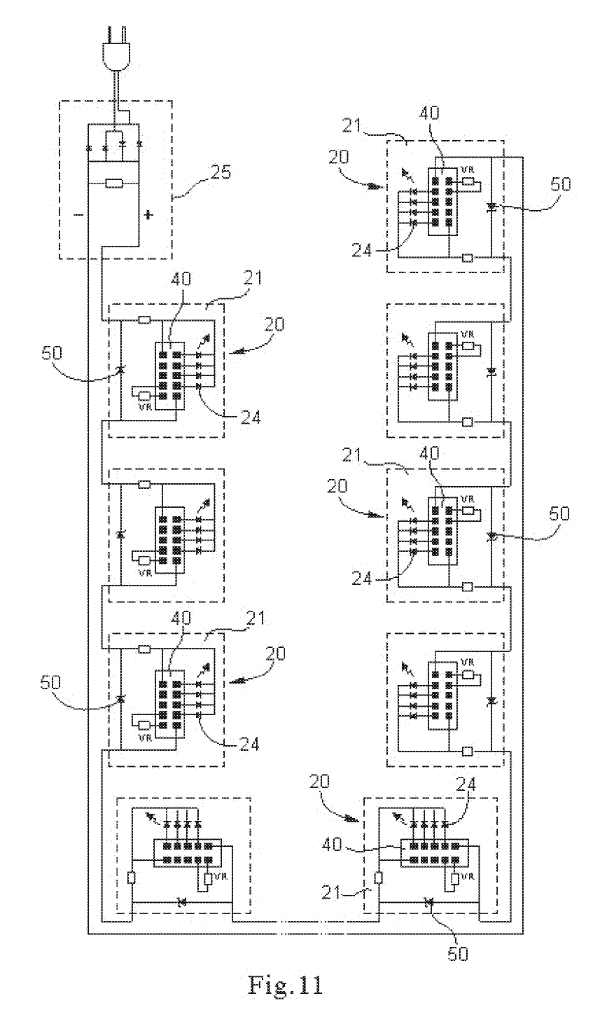

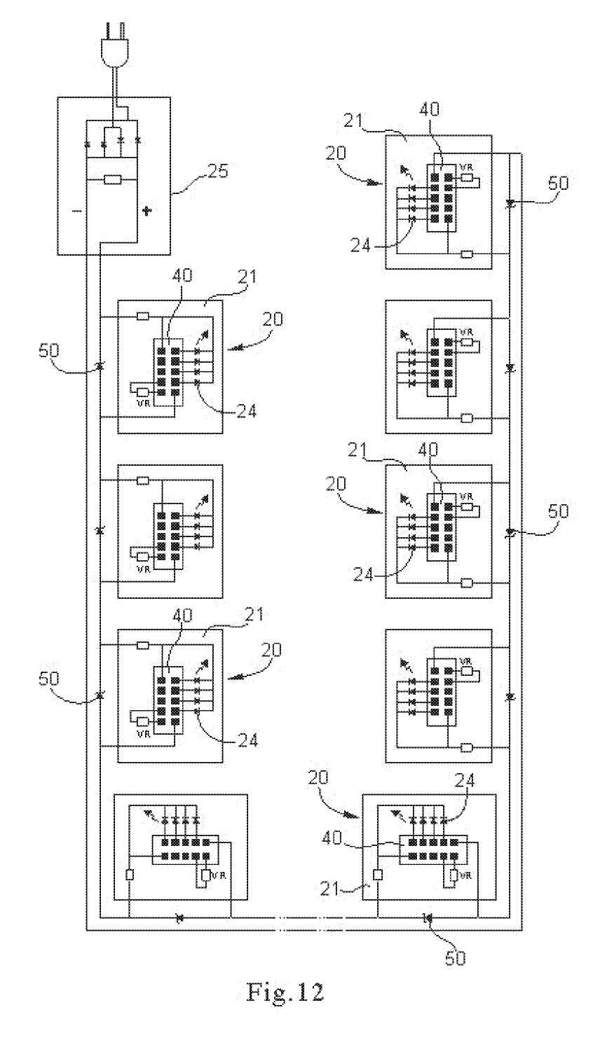

FIGS. 7 to 12 provide a third and a fourth preferred embodiment of the present invention relating to single-bulb polychromatic LEDs 20. In the single-bulb polychromatic LED 20, a anode pin 22 and a cathode pin 23 are provided inside a casing 21 of a single-bulb polychromatic LED 20, while a control IC 40 is disposed at an end portion of the anode pin 22 (or cathode pin 23) and a plurality of LED chips 24 of different colors are deposited at an end portion of the cathode pin 23 (or anode pin 22). The control IC 40 is connected to the LED chips 24 via lead wires 41 respectively so as to control the LED chips 24. A plurality of the single-bulb polychromatic LEDs 20 are connected in series to form an LED string light. The LED string light is equipped with a rectifying circuit 25 for providing a low DC voltage so as to drive the control IC 40 of each of the single-bulb polychromatic LEDs 20 and enable the control IC 40 to control each of the LED chips 24, thereby allowing the single-bulb polychromatic LEDs 20 of the LED string light to glitter by alternating between ON and OFF states in a pre-programmed sequence. The present invention is characterized by a Zener diode 50 connected between the anode pin 22 and the cathode pin 23 of each of the single-bulb polychromatic LEDs 20. The Zener diode 50 between the anode and cathode pins 22, 23 may be settled inside or outside the casing 21. Once power interruption arises from a failure of one of the single-bulb polychromatic LEDs 20 of the LED string light, the Zener diode 50 connected between the anode and cathode pins 22, 23 of the malfunctioning single-bulb polychromatic LED 20 will instantly restore electrical conduction, allowing the LED string light to function normally, well, and without interruption. Accordingly, a power interruption protection structure for an LED string light of the present invention excels a conventional LED string light for preventing complete failure, and allowing the malfunctioning single-bulb polychromatic LED 20 to be identified with naked eyes so to facilitate maintenance and replacement.

In short, the Zener diode provided between the anode and cathode of each of a plurality of the single-bulb monochromatic or single-bulb polychromatic LEDs connected in series as the LED string light, in strength of its electronic properties, serves to instantly restore electrical conduction when the LED fails. Hence, the LED string light functions well and without interruption, not to mention that the malfunctioning LED is readily identified to facilitate maintenance and replacement. Compared to a conventional LED string light, the disclosed power interruption protection structure for the LED string light is novel, non-obvious and useful.

What is claimed is:

1. A power interruption protection structure for an LED string light, wherein the LED string light comprises a plurality of single-bulb monochromatic or single-bulb polychromatic LEDs connected in series, characterized by a Zener diode connected between an anode and a cathode inside or outside a casing of each of said LEDs and serving to restore an electrical conduction of the LED instantly when the LED fails.
